(19) United States
(12) Patent Application Publication
(10) Pub. No.: US 2020/0224066 A1
(43) Pub. Date: Jul. 16, 2020

(54) High Performance Reactive Pressure Sensitive Adhesive Composition

(71) Applicants: Biao SHEN, Glendale, CA (US); Yurun YANG, Glendale, CA (US); Yuanhua ZHU, Glendale, CA (US); Shaohua WANG, Glendale, CA (US); Xiaoming PAN, Glendale, CA (US); Jun J. ZHANG, Glendale, CA (US); Avery Dennison Corporation, Glendale, CA (US)

(72) Inventors: Biao SHEN, Shanghai (CN); Yurun YANG, Shanghai (CN); Yuanhua ZHU, Kunshan City (CN); Shaohua WANG, Kunshan (CN); Xiaoming PAN, Kunshan (CN); Jun J. ZHANG, Shanghai (CN)

(21) Appl. No.: 16/495,251

(22) PCT Filed: May 8, 2017
(86) PCT No.: PCT/CN2017/083492

§ 371 Date: Sep. 18, 2019

(51) Int. Cl. C09J 109/06; C09J 153/02; C09J 7/38; G09F 3/10; G09F 3/02; G09F 23/00

(52) U.S. Cl. CPC C09J 109/06; C09J 153/02; C09J 7/387; G09F 3/10; G09F 3/02; G09F 2003/023; C09J 2453/00; C09J 2407/00; C09J 2203/334; C09J 2409/00; C09J 2461/00; G09F 23/00

(57) ABSTRACT

Provided herein is a high performance reactive pressure sensitive adhesive (HPR-PSA) formulation which can be compounded and coated on facestock at ambient temperatures. Upon curing by exposing to a high temperature, the HPR-PSA becomes a structural adhesive with superior mechanical performance. This HPR-PSA formulation comprises the unique mixture of the SIS and SB rubber, hydrocarbon and rosin resins tackifiers, and a phenolic derivative curing agent.

### FIELD OF THE INVENTION

The present invention relates generally to pressure sensitive adhesives (“PSAs”), in particular to high performance reactive PSAs (“HPR-PSAs”). The application also relates to labels containing the HPR-PSAs.

### BACKGROUND OF THE INVENTION

PSAs are easy to handle in solid form. They can quickly form adhesive bonds without significant supplemental processing. PSAs generally have a long shelf life and can provide a convenient and economical way to label articles of commerce, such as glass, metal, and plastic containers for consumer and industrial products. PSAs are thus widely used for the manufacture of self-adhesive labels, which are fastened to the articles for the purpose of presenting information (such as a barcode, description, or price) and/or for decorative purposes.

Conventionally, label and tape applications use hotmelt PSA because of its good workability during application. However, hotmelt PSA tends to creep under load and cannot be used in applications that require very high levels of holding power and lap shear strength. An example of these applications is automobile tire labels.

Other labels and tape applications involve cross-linked PSA. The adhesive in these labels comprise curing agents which react with base polymer during the coating of the adhesive to the facestock. In use, the cross-linking reactions do not occur upon attachment of the label to the substrate.

U.S. Pat. No. 5,439,963 describes a pressure sensitive adhesive having a thermoplastic elastomeric component comprising about 50-100 parts of a diblock styrene-isoprene copolymer and about 0-50 parts of a styrene-isoprene-styrene triblock copolymer. The adhesive comprises about 25-150 parts per 100 parts of a tackifier resin for said elastomeric component, and about 5-40 parts of a heat reactive phenolic resin curing agent for said adhesive.

U.S. Pat. No. 5,274,036 discloses a pressure sensitive adhesive comprising a solid rubber and a liquid rubber in a ratio of about 1:0.5 and about 1:7. The solid rubber comprises a block copolymer having the configuration A-B-A wherein each A is a thermoplastic styrene polymer block, the total block A content being from about 5 to about 50 percent by weight of the block copolymer and B is an elastomeric polymer block of isoprene. It also discloses using a heat reactive phenol formaldehyde resin as a curing agent by using about 5-40 parts of phenol formaldehyde resin with about per 100 of solid rubber.

U.S. Pat. No. 3,232,429 discloses a pressure-sensitive adhesive comprising an aldehyde resin reactive elastomer, a tackifier, a curing agent and a compatible acid accelerator. The elastomer may be a butadiene and styrene copolymer and the curing agent may be alkylphenol-formaldehyde resins.

Generally speaking, these PSAs are already crosslinked before being applied to the substrate; the crosslinking reactions are completed during the coating of the PSA to the facestock. Even in view of these references, the need remains for a reactive PSA, which remains substantially uncrosslinked during the coating process, but becomes crosslinked and becomes a structure adhesive upon curing under high temperatures typically required for applications, such as vulcanization of tires.

### SUMMARY OF THE INVENTION

Disclosed herein is a unique high performance reactive pressure se (“HPR-PSA”) composition and a process to coat this PSA. The adhesive not only has features of a PSA, e.g., good adhesive and reposition performance and coatability during assembly process, but also has the performance of a structure adhesive upon being cured at an elevated temperature, e.g., high static shear and peel strength.

In one aspect, provided herein is an adhesive comprising: a first rubber comprising a styrene-isoprene-styrene (“SIS”) copolymer, a second rubber comprising a styrene-butadiene (“SB”) copolymer. In some embodiments, the weight ratio of SIS copolymer to SB copolymer ranges from 4:1 to 0.25:1. The adhesive further comprises a tackifier that is a mixture of hydrocarbon resin and rosin resin and a curing agent that is a phenolic resin.

In some embodiments, the curing agent comprises a phenolic derivative and is essentially free of sulfur. In one particular embodiment, the phenolic derivative comprises bromized phenol formaldehyde, e.g., bromized alkyl phenol formaldehyde.

The adhesive may comprise from 10 to 50 wt % SIS copolymer, based on the total weight of the adhesive. The adhesive may comprise from 10 to 50 wt % SB copolymer, based on the total weight of the adhesive. In some cases, the weight ratio of the tackifier to the combined SIS and SB copolymers ranges from 1:9 to 4:1. In some embodiments, the amount of rosin resin in the adhesive ranges from 5 to 40 wt % based on the total weight of the adhesive. In some embodiments, the adhesive of any of the preceding claims, wherein the amount of hydrocarbon resin in the adhesive ranges from 5 to 40 wt % based on the total weight of the adhesive. In some embodiments, the weight ratio of hydrocarbon resin to rosin resin ranges from 5:1 to 1:5. In some embodiments, the total amount of tackifier ranges from 10 to 75 wt % based on the total weight of the adhesive.

In some embodiments, the hydrocarbon resin in the adhesive is selected from the group consisting of aliphatic hydrocarbon having 5 carbon atoms, aromatic hydrocarbon having 9 carbon atoms, dicyclopentadiene, and mixtures thereof. In some embodiments, the rosin resin is selected from the group consisting of glycerol ester, pentaerythritol ester, and mixtures thereof. In some embodiments, the curing agent is a mixture of alkyl phenol formaldehyde and bromized alkyl phenol formaldehyde. In some embodiments, the amount of curing agent ranges from 1 to 15 wt % based on the total weight of the adhesive. In some embodiments, the curing agent has a methylol content that ranges from 7 wt % to 13 wt % based on the weight of the curing agent.

In some embodiments, the adhesive demonstrates a storage modulus of at least 300 Pa at 170° C. before being cured. In some embodiments, the adhesive demonstrates a storage modulus of at least 1800 Pa at 170° C. after being cured at 170° C. for 10 minutes, or the adhesive demonstrates at least a 5-fold increase as compared to the storage modulus before curing. In some embodiments, the adhesive demonstrates a peel strength of at least 8 Newton/inch on stainless steel according to the FINAT-1 (2016) method before curing. In some embodiments, the adhesive demonstrates a shear strength of at least 10,000 minutes on stainless steel according to the FINAT-8 (2016) method before curing. In some embodiments, the adhesive demonstrates a lap shear ranging from 0.05 MPa to 2 MPa on stainless steel before curing. In some embodiments, the adhesive demonstrates a lap shear of at least 1 Mpa on stainless steel after curing. In some embodiments, the adhesive demonstrates a D-shear ranging from 5 to 300 Newton/inch before curing. In some embodiments, the adhesive demonstrates a D-shear ranging from 100-2,000 Newton/inch after curing.

In another aspect, this disclosure provides an adhesive solution for coating a facestock comprising: a first rubber comprising a styrene-isoprene-styrene (“SIS”) copolymer, a second rubber comprising a styrene-butadiene (“SB”) copolymer, a tackifier comprising a hydrocarbon resin and a rosin resin, a solvent, and a curing agent, wherein the curing agent is phenolic resin, wherein the weight ratio of SIS to SB copolymers ranges from 4:1 and 0.25:1. In some embodiments, the adhesive solution comprises between 25 wt % and 75 wt % solvent based on the total weight of the adhesive solution. In some embodiments, the adhesive solution demonstrates a viscosity of 100-5000 cps. In some embodiments, the adhesive solution has a solid content ranging from 30 wt % to 75 wt %. In some embodiments, the solvent used to prepare the adhesive solution is an aromatic solvent.

In yet another aspect, this disclosure provides a method of producing an adhesive solution comprising dissolving in a solvent at a temperature of less than 50° C. i) a first rubber comprising SIS copolymer, a second rubber comprising a SB copolymer, ii) a tackifier comprising a hydrocarbon resin and a rosin resin, iii) a curing agent, wherein the curing agent is phenolic resin to form an adhesive solution. In some embodiments, the weight ratio of SIS to SB copolymers ranges from 4:1 and 0.25:1.

In some embodiments, the method further comprises coating a facestock with the adhesive solution described above and drying the adhesive solution at a temperature of less than 110° C. to produce an adhesive layer on the facestock.

In yet another aspect, this disclosure provides a method for producing an adhesive, wherein the method comprises a) dissolving in a solvent at ambient temperature i) a first rubber comprising SIS copolymer, a second rubber comprising a SB copolymer, ii)a tackifier comprising a hydrocarbon resin and a rosin resin, iii) a curing agent, wherein the curing agent is phenolic resin to form an adhesive solution, wherein the weight ratio of SIS to SB copolymers ranges from 4:1 and 1:4, b) coating a facestock with the adhesive solution, and c) drying the adhesive solution at a temperature of less than 110° C., wherein the SIS and SB copolymers are substantially uncrosslinked.

In yet another aspect, this disclosure provides a label comprising a facestock and an adhesive, wherein the adhesive is coated on the facestock and the adhesive comprises: a) a first rubber comprising a styrene-isoprene-styrene (“SIS”) copolymer, b) a second rubber comprising a styrene-butadiene (“SB”) copolymer, c) a tackifier that is a mixture of hydrocarbon resin and rosin resin, and d) a curing agent comprising a phenolic resin, wherein the weight ratio of SIS to SB copolymers ranges from 4:1 to 0.25:1, and wherein the SIS and the SB copolymers are substantially uncrosslinked.

In some embodiments, the SIS and the SB copolymers of the adhesive are crosslinked to a degree of between 10% to 45% after the adhesive is cured at 170° C. for 10 min.

### BRIEF DESCRIPTION OF DRAWINGS

The invention is described in detail below with reference to the appended drawing.

FIG. 1 shows the result of a DSC analysis of the HPR-PSA demonstrating the reactivity of the adhesive and change in performance after the curing reaction.

FIG. 2 shows the results of a rheology analysis demonstrating the reactivity of the adhesive and change in performance after the curing reaction.

FIG. 3 shows the results of time scanning experiments (at 200° C.) to show operation window for curing the HPR-PSA.

FIG. 4 shows the results of experiments of time scanning (at 140° C.) to show operation window for curing of the HPR-PSA.

### DETAILED DESCRIPTION OF THE INVENTION

Some conventional pressure sensitive adhesives having a thermoplastic elastomeric component comprise diblock styrene-isoprene copolymer and a styrene-isoprene-styrene triblock copolymer along with a tackifier resin and a heat reactive phenolic resin curing agent. These PSAs do not utilize a styrene-butadiene copolymer in the thermoplastic elastomeric component and do not employ hydrocarbon or rosin as tackifiers. These conventional PSAs may be prepared by mixing the components to form a hot melt adhesive, as opposed to dissolving the components in a solvent to form a solution. The hot melt adhesive may then be coated on a facestock under high temperature. The high temperature triggers the curing reaction of the curing agent present in the adhesive while the hot melt adhesive is being coated on the facestock. Unfortunately, the performance characteristics of these PSAs are often insufficient for applications where high structural strength, static shear, and peel strength are desired. Also, with these PSAs, there is no need for the step of drying the adhesive solution after the adhesive is coated on the facestock. Drying is not necessary because no solvent is involved in the preparation process.

Some other PSAs are solvent-based PSAs and comprise a curing agent. With these PSAs, the cross-linking of the adhesive occurs before application of the label to the substrate;. The crosslinking reactions are completed during the coating of the PSA to the facestock. Essentially no reactions typically occur after the attachment of the label to the substrate.

Some other conventional PSAs comprise a solid rubber and a liquid rubber. The solid rubber may comprise a block copolymer. A heat reactive phenol formaldehyde resin may be used as a curing agent. Also, these adhesives do not contain the diblock copolymer of styrene-butadiene. As a result, the adhesive may lack desired balancing of tack and adhesion properties as well as good mechanical properties. Still other PSAs comprise a pressure-sensitive adhesive comprising an aldehyde resin reactive elastomer, a tackifier, a curing agent and a compatible acid accelerator. The elastomer may be a butadiene and styrene copolymer and the curing agent may be alkylphenol-formaldehyde resins. However, these PSAs may suffer from the same lack of performance characteristics mentioned above.

The inventors have now discovered that the combination of a first rubber comprising an styrene-isoprene-styrene (“SIS”) copolymer (particularly at a weight ratio ranging from 4:1 to 1:4), a second rubber comprising a styrene-butadiene (“SB”) copolymer, specific tackifiers, e.g., hydrocarbon and rosin resins, and a sulfur free phenolic derivative curing agent in specific proportions surprisingly yields a high performance reactive PSA (“HPR-PSA”). This HPR-PSA demonstrates a unique combination of performance characteristics, e.g., stainless steel peel strength and/or lap shear. Without being bound by theory, it is believed that the (at least) two specific rubbers, at a specific weight ratio, react with the particular curing agent such that it achieves viscoelastic property that is optimal for PSA application. SIS possesses higher glass transition temperature (“Tg”) than SB. SIS provide higher cohesion and SB provides better low temperature usability and die cutting properties. The combination of SIS copolymer and SB copolymer in proportional amounts imparts desired viscoelastic property which is helpful to PSA application. The resultant HPR-PSA can be easily applied, e.g., in a manner that is suitable for applying solvent borne PSA, to any facestock to produce a label, and the label so produced has excellent adhesion performance, removability and repositionability. Unlike a typical hotmelt, when the HPR-PSA/label are heated to or above a threshold (“triggering temperature”), the curing agent present in the PSA crosslinks the base copolymers and permanently adheres the label to the substrate. The cured HPR-PSA becomes a structural adhesive. As a result, the cured label exhibits superior mechanical properties such as superior strong static shear, storage modulus, and peel strength.

The inventors have also found that the use of phenolic derivatives at an amount within certain ranges as curing agents unexpectedly provide for a higher triggering temperature as compared to other type of curing agent. As compared to conventional PSAs containing curing agent, where the HPR-PSA is crosslinked during the coating process, which is typically performed at a temperature of 110° C. or less, the special formulation of the HPR-PSA disclosed in this application allows a formation of stable HPR-PSA-facestock laminate while the HPR-PSA remains substantially uncrosslinked. Only when the HPR-PSA is exposed at a high temperature that is typical for normal vulcanization condition (160-200° C.), the curing reaction will be triggered. Thus, the higher triggering temperature ensures the stability of the HPR-PSA, i.e, the adhesive curing reaction may occur during vulcanization, and will not occur during the compounding or coating process or in storage.

Further, in forming the label, the use of the specific components in the HPR-PSA advantageously provides for a coated adhesive in which the copolymers do not (substantially) crosslink upon application to the facestock, i.e., the copolymers remain substantially uncrosslinked. This benefit is important because it allows the crosslinking to occur at a later point, e.g., when the label is applied to a desired substrate, and the crosslinking occurs between the label and the substrate, which provides for a superior bond to the substrate. In conventional products, the crosslinking occurs during application to the facestock, which has little or no effect on the strength of the bond of the label to the desired substrate. It will be appreciated by those skilled in the art that the term “substantially uncrosslinked” is used herein to refer to relatively lowly crosslinked copolymers, e.g., the status of SIS and SB copolymers before the curing reaction. For example, substantially uncrosslinked copolymers may refer to a copolymer resin, in which less than less than 5 wt %, less than 3 wt %, or less than 2 wt % of the copolymers are crosslinked. For purpose of this disclosure, the term “crosslinked” refers to the status of the SIS and SB copolymers after the curing reaction is initiated, in which at least 15 wt %, at least 18 wt %, or at least 20 wt %, or at least 24 wt %, at least 30 wt %, or at least 40 wt %, or at least 41.3 wt % of the copolymers are crosslinked.

### Polymer/Copolymer

The (co)polymers of the high performance reactive PSA (“HPR-PSA”) comprise a styrene-isoprene-styrene copolymer (SIS block copolymer) and a styrene-butadiene copolymer (SB block copolymer), where “S” denotes a polymerized segment or “block” of styrene monomers, “I” denotes a polymerized segment or “block” of isoprene monomers, and “B” denotes a polymerized segment or “block” of butadiene monomers.

The inventors have found that the unique proportional combination of SIS and SB copolymers in the HPR-PSA contributes to balanced properties of mechanical performance, such as peel and static shear. The unique proportional combination of the copolymers and the curing agent contributes to curing properties and thus the reactivity. For example, the SIS copolymer in the adhesive beneficially can be easily tackified and can contribute excellent adhesion performance to the adhesive.

SB has acceptable mechanical performance and imparts HPR-PSA with good low temperature usability due to the lower Tg and die cutting property. SB copolymer is also relatively inexpensive, as compared to SIS, but has the drawbacks of being easily oxidized and difficult to tackify. Adhesives having excessive SB copolymer could also exhibit poor resistance to chemicals and oil substances and the inability of withstanding long-time exposure to sunlight ozone and heat. As noted above, the combination of these specific copolymers at the specific weight ratio provides for a unique combination of performance characteristics.

The molecular weight of the SIS may also impact the adhesion performance. It is postulated that the higher molecular weight and/or the higher the styrene content surprisingly improves adhesion performance it would possess. In one embodiment, the molecular weight of the SIS copolymer ranges from 7,000-400,000 g/mole, e.g., from 70,000-300,000 g/mole, or from 100,000-300,000 g/mole. In terms of upper limits, the SIS copolymer can have a molecular weight less than 400000 g/mole, e.g., less than 300000 g/mole, less than 100000 g/mole. In terms of lower limits, the SB copolymer can have a molecular weight greater than 7000 g/mole, greater than 8000 g/mole, greater than 10000 g/mole, or greater than 20000 g/mole.

It is believed that styrene, when present in amounts within certain ranges, can impart the HPR-PSA with optimal pre-cure peel and static shear strength. Increasing the styrene content can enhance the tensile strength post-cure, but too much styrene will sacrifice the pressure sensitive properties for the pre-cure HPR-PSA, wherein the HPR-PSA remains substantially uncrosslinked. In one embodiment, the SIS copolymer has a styrene content ranged from 10 wt % to 50 wt %, e.g., from 15 wt % to 30 wt %, from 20 wt % to 30 wt %, from 16 wt % to 25 wt %, or from 18 wt % to 20 wt %, based on the weight of the SIS copolymer. In terms of upper limits, the styrene content in the SIS copolymer can be less than 30 wt %, e.g., less than 26 wt %, or less than 25 wt %. In terms of lower limits, the styrene content in the SIS copolymer can be greater than 8 wt %, e.g., greater than 10 wt %, or greater than 16 wt %.

The SB copolymer used in this invention typically has a molecular weight ranged from 7000 g/mole to 400000 g/mole, more preferably from 70000 g/mole to 300000 g/mole, or from 100,000 g/mole to 300,000 g/mole. In terms of upper limits, the SB copolymer can have a molecular weight less than 400,000 g/mole, e.g., less than 300,000 g/mole, less than 100,000 g/mole. In terms of lower limits, the SB copolymer can have a molecular weight greater than 7000 g/mole, greater than 8,000 g/mole, greater than 10,000 g/mole, or greater than 20,000 g/mole.

In some embodiments, the styrene content of the SB copolymer can range from 10 wt % to 50 wt %, from 15 wt % to 30 wt %. e.g., from 20 wt % to 30 wt %, from 16 wt % to 25 wt %, or from 18 wt %-20 wt % based on the weight of the SB copolymer. In terms of upper limits, the styrene content of the SB copolymer can be less than 35 wt %, e.g., less than 30 wt %, less than 25 wt %, or less than 20 wt %. In terms of lower limits, the styrene content of the SB copolymer may be greater than 5 wt %, e.g., greater than 10 wt %, greater than 15 wt %, or greater than 17 wt %.

In some embodiments, the weight ratio of SIS tri-block copolymer to SB di-block copolymer may range from 4:1 to 1:0.25, e.g., from 4:1 to 0.33:1, from 3:1 to 0.67:1, or about 1.5:1. In some embodiments, the SIS copolymer content can range from 10 wt % to 50 wt %, 18 wt % to 40 wt % based on the total weight of the adhesive, e.g., from 20 wt % to 35 wt %, from 25 wt % to 35 wt %, from 20 wt % to 25 wt %, from 35 wt % to 40 wt %, or from 22 wt % to 35 wt %, e.g., about 22.6 wt %. In terms of upper limits, the SIS copolymer content can be less than 50 wt %, less than 40 wt %, e.g., less than 38 wt %, less than 37 wt %, less than 36 wt %, less than 35 wt %, less than 32 wt %, less than 31 wt %, less than 29 wt %, less than 28 wt %, less than 27 wt %, or less than 25 wt %. In terms of lower limits, the SIS copolymer content can be at least 5 wt %, at least 10 wt %, at least 15 wt %, at least 20 wt %, at least 25 wt %, at least 30 wt %, or at least 35 wt %.

In some embodiments, the SB copolymer content can range from 3 wt % to 60 wt %, e.g., 5 wt % to 45 wt %, 10 wt % to 50 wt %, 10 wt % to 25 wt %, from 5 wt % to 30 wt %, from 10 wt % to 25 wt %, from 15 wt % to 20 wt %, from 12 wt % to 18 wt %, from 13 wt % to 20 wt %, or about 15.2 wt %. In terms of upper limits, the SB copolymer can be less than 40 wt %, e.g., less than 35 wt %, less than 50 wt %, less than 45 wt %, less than 40 wt %, less than 35 wt %, less than 30 wt %, less than 25 wt %, less than 20 wt %, less than 18 wt %, less than 17 wt %. In terms of lower limits, the SB copolymer content can be greater than 5 wt %, greater than 8 wt %, greater than 10 wt %, greater than 12 wt %, greater than 13 wt %, greater than 14 wt %, or greater than 15 wt %.

### Tackifier

The HPR-PSA of the invention comprises a tackifier. The tackifier may have a particular compatibility with the base copolymers SIS and SB, e.g., a synergistic combination that contributes to the tack and adhesion properties of the adhesive. The inventors has discovered that, hydrocarbon resin and rosin resin, optionally when used at certain weight ratios, offer an advantageous balance of adhesive properties and provide for adhesion improvements between SIS and SB copolymers.

Hydrocarbon resins are often thermoplastic resins that promote adhesion and tack in pressure sensitive adhesives. Hydrocarbon tackifiers are made from petroleum based feedstocks such as aliphatic hydrocarbon resin having five carbon atoms (C5), aromatic hydrocarbon resin having nine carbon atoms (C9), dicyclopentadiene (DCPD), Wingtack 10 (a C5 hybrocarbon resin), C6100 (a mixture of C5 and C9 hydrocarbon resin), or mixtures thereof. Hydrocarbon resins have been found to demonstrate good solubility and compatibility with the base copolymer. Hydrocarbon resins also provide the benefit of allowing the adhesive to work well on low surface energy substrate.

In some embodiments, the amount of hydrocarbon resin in the adhesives ranges from 0 wt % to 50 wt %, based on the total weight of the adhesive, e.g., 2% to 45%, 5 wt % to 40 wt % from 10 wt % to 30 wt %, e.g., from 20 wt % to 40 wt %, e.g., about 39 wt %. In terms of upper limits, the amount of hydrocarbon resin in the adhesive can be less than 45 wt %, e.g., less than 40 wt %, less than 35 wt %, less than 30 wt %, based on the total weight of the adhesive. In terms of lower limits, the amount of hydrocarbon resin in the adhesive is greater than 10 wt %, e.g., greater than 15 wt %, greater than 20 wt %, greater than 30 wt %, based on the total weight of the adhesive.

Suitable commercial hydrocarbon resins include T-500 or TD-110 from Rayton, Piccotac 1095 or Piccotac 1100 from EASTMAN.

Rosin resins are the thermoplastic ester resins produced by reacting rosin acid with alcohol. They are typically derived from either aged tree stumps (wood rosin), sap (gum rosin), or by-products of the paper making process (tall oil rosin) and they impart excellent, aggressive adhesion to all polymer types. Non-limiting examples of rosin include glycerol ester and pentaerythritol esters.

The inventors have found that the presence of rosin resin in the HPR-PSA contributes to the stability and longevity properties of the adhesive, however excessive amount of rosin resin increases the chance of damaging the hard domains comprising the styrene groups in the SIS or SB copolymer and thus reducing the shear strength of HPR-PSA. In preferred embodiments, the rosin resin is present in an amount ranging from 0 wt % to 50 wt % based on the total weight of the adhesive, e.g., from 1 wt % to 45 wt %, from 5 wt % to 40 wt %, from 10 wt % to 25 wt %, from 10 wt % to 20 wt %, e.g., about 17 wt %. In terms of upper limits, the amount of rosin may be less than 40 wt %, less than 25 wt %, or less than 20 wt %. In terms of lower limits, the amount of rosin may be greater than 5 wt %, e.g., greater than 10 wt %, greater than 15 wt %, or greater than 16 wt % based on the total weight of the adhesive.

Suitable commercial rosin resins include GA100F, GB75 GA90 GA85, or GB100 from ARAKAWA.

The inventors of the application have discovered that combining hydrocarbon and rosin tackifiers at ratios within a particular range provides for desired stability, longevity, and adhesion performance. In some embodiments, the weight ratio of the hydrocarbon resin to rosin resin ranges from 1:0 to 0:1, e.g., from 1:0 to 0.25:1, from 5:1 to 0.2:1, from 3:1 to 0.33:1, between 1:1 to 3:1, or between 2:1 and 0.5:1, e.g., about 2.3:1. In terms of upper limits, the weight ratio of hydrocarbon resin to rosin resin is less than 1:0, e.g., less than 5:1, less than 4:1, less than 3:1, or less than 2.5:1. In terms of lower limits, the weight ratio of hydrocarbon resin to rosin resin is greater than 0:1, e.g., greater than 0.2:1, greater than 0.25:1, or greater than 0.33:1.

The amount of total tackifier present in the HPR-PSA may range from 10 wt % to 75 wt %, e.g., from 40 wt %-75 wt %, from 20 wt % to 70 wt %, from 40 wt % to 65 wt %, e.g., about 56.2 wt %, based on the total weight of the adhesive. In terms of upper limits, the amount of total tackifier may be less than 80 wt %, less than 75 wt %, less than 70 wt %. In terms of lower limits, the amount of total tackifier may be greater than 20 wt %, e.g., greater than 30 wt %, greater than 40 wt %, or greater than 45 wt %, based on the total weight of the adhesive.

In some embodiments, the weight ratio of the base copolymers, e.g., SIS and SB copolymers, ranges from 0.11:1 to 0.25:1, e.g., from 0.2:1 to 4:1, from 0.33:1 to 3.5:1, from 0.5:1 to 3:1, or from 1:1 to 3:1. In terms of upper limits, the weight ratio of tackifiers to base copolymers is less than 4:1, e.g., less than 3:1, or less than 2:1. In terms of lower limits, the weight ratio of tackifiers to base copolymers is greater than 0.11:1, e.g., greater than 0.16:1, greater than 0.25:1, or greater than 0.33:1.

### Curing Agent

The HPR-PSA comprises a curing agent comprising phenolic resin. The phenolic resin can comprise one or more phenolic derivatives. Phenolic resins have been found to have good chemical resistance and adhesion to substrates and when properly formulated phenolic resins can retain properties at elevated temperatures. In preferred embodiments, the curing agent used in the HPR-PSA comprises bromized alkyl phenol formaldehyde. In some embodiments, the curing agent comprises a mixture of alkyl phenol formaldehyde and bromized alkyl phenol formaldehyde.

In some embodiments, the curing agent is essentially free of sulfur. Using sulfur-free curing agent has been found to be surprisingly beneficial because it avoids the contamination problem caused by using sulfur based phenolic derivatives. In some embodiments, the curing agent comprises bromized phenol formaldehyde.

In preferred embodiments, the curing agent used in the HPR-PSA comprises methylol groups. The amount of methylol groups in the curing agent is directly correlated with the level of crosslinking density. A high methylol content however may cause it harder to solidify. The inventors of the application discovered surprisingly methylol group content within a defined range offers the optimum crosslinking densities and impart the desired adhesion and mechanical performance. For example, the methylol content in the curing agent used in the disclosed HPR-PSA may range from 5 wt % to 18 wt %, e.g., from 7 wt % to 15 wt %, 7 wt % to 13 wt %, from 10 wt %-13 wt %, from 8 wt % to 12 wt %, from 9 wt % to 13 wt %, or from 9 wt % to 11 wt %, based on the total weight of the curing agent in the HPR-PSA. In terms of upper limits, the methylol content in the curing agent used in the disclosed HPR-PSA is less than 15 wt %, e.g., less than 13 wt %. In terms of lower limits, the methylol content in the curing agent used in the disclosed HPR-PSA is greater than 7 wt %, e.g., greater than 8 wt %, or greater than 9 wt %. In a particular embodiment, the phenolic resin used as the curing agent is SP1056.

In one embodiment, the amount of curing agent in the HPR-PSA ranges from 0.8 wt % to 16.0 wt % based on the total weight of the HPR-PSA, e.g., from 1.0 wt % to 15 wt %, from 2.5 wt % to 8.0 wt %, from 3.5 wt % to 8.0 wt %, from 4 wt % to 7.0 wt %, from 5 wt % to 10.0 wt %, or from 4.5 wt % to 7.0 wt %, e.g., about 5.7 wt %. In terms of upper limits, the amount of curing agent is less than 20.0 wt %, e.g., less than 18.0 wt %, less than 15.0 wt %, or less than 10.0 wt %. In terms of lower limits, the amount of curing agent is greater than 0.8 wt %, e.g., greater than 1.0 wt %, greater than 1.3 wt %, or greater than 1.5 wt %.

The curing agent disclosed herein can cure the base copolymers under broad conditions. The HRP-PSA having the curing agent disclosed herein typically becomes reactive when the temperature is above a threshold of temperature, commonly referred to as triggering temperature. In practice, curing occurs after the HPR-PSA is assembled into a label with other layers and the resulted layer is attached to a substrate, for example, a tire. In some embodiments, the triggering temperature for curing ranges from 135° C. to 200° C., e.g., 135° C. to 180° C., e.g., from 160° C. to 180° C., from 145° C. to 175° C., from 150° C. to 200° C. or from 155° C. to 185° C. In terms of upper limits, the triggering temperature can be less than 200° C., e.g., less than 195° C., less than 185° C., or less than 180° C. In terms of lower limits, the triggering temperature can be greater than 120° C., greater than 125° C., or greater than 130° C. In general, exposing adhesives in excessive high temperature for an extended period of time may cause excessive crosslinking or degradation of the adhesive. Excessive crosslinking would undermine the mechanical properties of the HPR-PSA, as shown by a reduction of storage modulus. This curing agent disclosed herein, e.g., a (bromized) alkyl phenol formaldehyde, can crosslink base copolymers under a broad range of temperatures and lengths of the period of time without causing excessive crosslinking. For example, the HPR-PSA can be cured at 155° C. to 185° C. for 10-30 minutes and still retain good storage modulus. In terms of upper limits, the time period for curing is less than 60 min, e.g., less than 40 min, or less than 30 min. In terms of lower limits, the time period for curing is greater than 5 min, e.g., greater than 8 min, greater than 12 min. In some embodiments, the HPR-PSA can be cured at 160° C. for 10 minutes, or 185° C. for 20 minutes, and retains good mechanical properties required for a structure adhesive.

### Production of the HPR-PSA

The HPR-PSA can be produced by mixing in proper solvent various components disclosed above, e.g., the SIS, SB copolymers, the tackifiers and curing agent, to produce an adhesive solution. This process is commonly referred to as compounding. The compounding can occur under a temperature that is less than 50° C., e.g., between 20° C. and 40° C., or between 20° C. and 30° C., or under any temperature below the triggering temperature for curing.

Solvents that are suitable for dissolving the components of the HPR-PSA include, but are not limited to, aromatic solvents, Ketones, aliphatic solvents and ester solvents. Such solvents may include ketones of from 3 to 15 carbon atoms (e.g., methyl ethyl ketone or methyl isobutyl ketone), alkylene glycols and/or alkylene glycol alkyl ethers having from 3 to 20 carbon atoms, acetates and their derivatives, ethylene carbonate, and other suitable solvents. Suitable alcohol solvents include mono-alcohols, such as methyl, ethyl, propyl, butyl alcohols, as well as cyclic alcohols such as cyclohexanol. In certain embodiments, a variety of acetate-type solvents may be used, such as n-butyl acetate, n-propyl acetate, and other acetate-type solvents. In preferred embodiments, the solvents are aromatic solvents. In certain embodiments, a portion of the solvent system may include water. In other embodiments, however, the solvent system may be devoid of water.

The amount of solvent(s) used for producing the HPR-PSA solution may vary depending on the desired viscosity. Typically the solvent is present in the HPR-PSA solution in an amount ranging from 25 wt % to 70 wt %, e.g., from 30 wt % to 65 wt %, from 40 wt % to 70 wt %, from 50 wt % to 70 wt %. In terms of lower limits, the solvent is present in an amount of greater than 30 wt %, greater than 40 wt %, greater than 50 wt %, or greater than 55 wt %, greater than 60 wt %, or about 58 wt %, based on the total weight of the HPR-PSA solution. In terms of upper limits, the solvent is present in an amount of less than 75 wt %, less than 70 wt %, or less than 65 wt %, based on the total weight of the HPR-PSA solution.

The HPR-PSA (and the adhesive solution thereof) can be used in a variety of applications. For example, it can be coated on a facestock, which is then processed and manufactured into labels. In some cases, it is used as a transfer adhesive without being associated with a facestock.

The HPR-PSA solution as prepared above has good coatability, with a typical viscosity of 100-5,000cps, e.g., 200-4,000 cps, 300-3,000 cps, 400-2,000 cps, 300-600 cps, or about 500cps. In terms of lower limits, the viscosity is greater than 100, e.g., greater than 200 cps, greater than 300 cps, or greater than 400 cps. In terms of upper limits, the viscosity is less than 5,000, less than 4,000 cps, less than 2,000 cps, less than 1,000 cps. Methods for measuring viscosity are well known, for example using the Brookfield Viscometer method, testing the flow resistance of the fluid by low and medium rate rotation.

Non-limiting examples of facestock that can be used include tissue, paper and film, e.g., a PET film, a polypropylene film, a Poly-vinyl Chloride film, a polyimide film, a polyethylene terephthalate film, a olefin film or a polyolefin film. In some embodiments, facestock used with the HPR-PSA are obtained from commercial sources, such as those available from Loparex, including products such as 1011, 22533 and 1 1404, CP Films, and Akrosil™.

### Coating

The HPR-PSA solution can be coated to a facestock using methods that are well known for solvent based adhesive, for example, as disclosed in Manufacturing Pressure-Sensitive Adhesive Products: A Coating and Laminating Process, available at www.adhesivesmag.com/articles/86079-manufacturing-pressure-sensitive-adhesive-products-a-coating-and-laminating-process, the content of which is hereby incorporated by reference in its entirety. The facestock that has been coated with the wet adhesive is then baked at a temperature to allow the solvent to evaporate. Preferably, the drying temperature for drying is lower than the curing triggering temperature to prevent crosslinking from occurring during the drying process.

In some embodiments, the coating is performed by direct coating, in which the pressure-sensitive adhesive is coated directly onto the facestock or backing material. In some embodiments, the coating is performed by transfer coating, in which the adhesive is first coated onto a release coated liner and transferred to the facestock or backing during the facestock/backing-to-liner lamination process.

Because of the unique composition of the HPR-PSA or a solution thereof, higher drying temperatures may be utilized without crosslinking the copolymers., which ultimately provides for superior label-substrate adhesion performance. In some embodiments, the drying temperature is no greater than 110° C., no greater than 105° C., or no greater than 100° C.

The inventors of the application have also discovered having a high solid content, for example at least 25%, e.g., at least 30%, at least 35%, at least 40%, at least 45% or at least 50%, is beneficial because it allows for efficient drying. The HPR-PSA solution of this disclosure may in some embodiments have a solid content that ranges from 30 wt % to 75 wt %, e.g., from 35 wt % to 70 wt %, from 30 wt % to 60 wt %, from 20 wt % to 50 wt %, or from 30 wt % to 55 wt % based on the total weight of the HPR-PSA solution. In terms of lower limits, the solid content of the HPR-PSA solution is greater than 20 wt %, greater than 30 wt %, greater than 35 wt %, greater than 40 wt %, or greater than 50 wt %. In terms of upper limits, the solid content of the HPR-PSA solution is less than 70 wt %, less than 65 wt %, less than 60 wt %, less than 55 wt %, or less than 50 wt %. In one embodiment the solid content of the HPR-PSA solution is about 42 wt %.

### Curing

Optionally, additional layers, such as primers and liners, can be assembled with the facestock coated with the HPR-PSA to form a label. The label can then be attached to suitable substrates, such as tires. In some embodiments, the label is exposed to high temperature for a period of time for curing, i.e., crosslinking of the base copolymers, to occur. In some embodiments, the label is treated at 155° C. -185° C. for 10-30 min. In some embodiments, the label is treated at 160° C. for 10 min or at 170° C. for 10 min. In some embodiments, the curing occurs at 185° C. for 20 min.

### Performance Characteristics

The HPR-PSA in this disclosure shows good adhesion performance, mechanical performance, repositionability and removability before curing. In some embodiments, the HPR-PSA may demonstrate a 180° C. peel strength that ranges from 5 Newton/inch to 30 Newton/inch according to the FINAT-1 method (2016), e.g., from 8 Newton/inch to 15 Newton/inch, or from 6 Newton/inch to 12 Newton/inch. In terms of lower limits, the HPR-PSA can demonstrate a peel strength of greater than 5 Newton/inch, e.g., greater than 6, greater than 8 Newton/inch. greater than 10 Newton/inch, greater than 12 Newton/inch, greater than 15 Newton/inch. In terms of upper limits, the HPR-PSA can demonstrate a peel strength of less than 100 Newton/inch, e.g., less than 80 Newton/inch, or less than 70 Newton/inch.

In one embodiment, the HPR-PSA demonstrates a sheer strength ranging from 1,000 min to 50,000 min on stainless steel before curing as measured using the FINAT-8 method (2016), e.g., from 8,000 min to 12,000 min, or from 9,000 min to 11,000 min. In terms of upper limits, the HPR-PSA can demonstrate a sheer strength of less than 18,000 min less than 15,000 min, less than 14,000 min, or less than 12,000 min. In terms of lower limits, the HPR-PSA can demonstrate a sheer strength of greater than 5,000 min, greater than 8,000 min, greater than 9,000 min, or greater than 10,000 min.

In some cases, the HPR-PSA demonstrates a storage modulus ranging from 6,000 Pa to 100,000 Pa at 25° C., e.g., 7,000 Pa to 60,000 Pa, or from 8,000 Pa to 50,000 Pa, or from 9,000 Pa to 30,000 Pa, or from 9,000 Pa to 12,000 Pa, or about 10,500 Pa before curing. In terms of upper limits, the HPR-PSA may demonstrate a storage modulus of less than 100,000 Pa, e.g., less than 30,000 Pa. or less than 20,000 Pa when measured at 25° C. In terms of lower limits, the HPR-PSA may demonstrate a storage modulus of greater than 6,000 Pa, e.g., greater than 7,000 Pa. or greater than 9,000 Pa before curing. When tested at 170° C., the HPR-PSA may demonstrate a storage modulus ranging from 100 Pa to 1,000Pa, e.g., 300 Pa to 900 Pa, 400 Pa to 800 Pa, 450 Pa to 600 Pa, e.g., about 490 Pa. In terms of lower limits, the HPR-PSA may demonstrate a storage modulus at 170° C. of greater than 100 Pa, 200 Pa, 300 Pa, or 400 Pa. In terms of upper limits, the HPR-PSA may demonstrate a storage modulus at 170° C. of less than 1,500 Pa, 1,000 Pa, 800 Pa, or 700 Pa.

The HPR-PSA may demonstrate a lap shear ranging from 0.05 MPa to 0.5 MPa, e.g., from 0.08 Mpa to 0.3 MPa, or from 0.05 Mpa to 0.2 Mpa, or from 0.10 Mpa to 0.15 Mpa, or about 0.12 MPa on stainless steel before curing. In terms of upper limits, the HPR-PSA may demonstrate a lap shear of less than 2 MPa, e.g., less than 1.0 MPa. or less than 800 Pa. In terms of lower limits, the HPR-PSA may demonstrate a lap shear of greater than 0.05 MPa, e.g., greater than 0.08 MPa. or greater than 0.11 MPa before curing.

In some cases, the HPR-PSA demonstrates a D-shear strength ranging from 10 Newton/inch to 100 Newton/inch, from 20 Newton/inch to 100 Newton/inch, from 50 Newton/inch to 100 Newton/inch, from 40 Newton/inch to 80 Newton/inch, or about 60 Newton/inch to 90 Newton/inch, or about 89 Newton/inch before curing. In terms of upper limits, the HPR-PSA can demonstrate a D-shear strength of less than 300 Newton/inch, less than 200 Newton/inch, less than 150 Newton/inch, or less than 120 Newton/inch. In terms of lower limits, the HPR-PSA can demonstrate a D-shear strength of greater than 10 Newton/inch, greater than 30 Newton/inch, or greater than 40 Newton/inch, or greater than 50 Newton/inch.

The HPR-PSA is transformed into a structure adhesive upon curing at the conditions as described above. In some cases, the HPR-PSA is part of a label and the label is then permanently adhered to the substrate once the HPR-PSA is cured. The cured HPR-PSA is crosslinked and generally exhibits significantly increased storage modulus and lap shear strength as compared to the HPR-PSA having the same compositions and having not been cured. In some cases, curing may increase the storage modulus of the HPR-PSA by at least 4 times, e.g., at least 5 times, at least 7 times, at least 8 times, at least 9 times, at least 10 times and the lab shear on stainless steel also increased at least 2 times, e.g., at least 5 times, at least 7 times, at least 8 times, at least 9 times, at least 10 times or at least 12 times, or at least 15 times relative to the storage modulus of the HPR-PSA that has not being cured. In some cases, the cured HPR-PSA shows a storage modulus of at least 500 Pa at 170° C., e.g., at least 600 Pa, at least 1000 Pa, at least 1500 Pa, at least 2000 Pa, at least 2400 Pa, or about 2490 Pa. In some cases, the cured HPR-PSA exhibits a lap shear of at least 1.0 MPa, at least 1.20 MPa, at least 1.50 MPa, or at least 1.12 MPa on stainless steel. When measured at 25° C., the cured HPR-PSA may demonstrate a storage modulus ranging from 100,000 Pa to 900,000 Pa, e.g., from 150,000 Pa to 600,000 Pa, from 200,000 to 500,000 Pa, or about 239,000 Pa.

In some cases, after curing, for example, at 135° C. -180° C. for 10-30 min, the cured HPR-PSA may demonstrate a D-shear strength ranging from 400 Newton/inch to 2,000 Newton/inch, from 500 Newton/inch to 1,500 Newton/inch, from 300 Newton/inch to 1800 Newton/inch, from 400 Newton/inch to 1,600 Newton/inch, or about 500 Newton/inch to 1,400 Newton/inch, e.g., about 1200 Newton/inch. In terms of upper limits, the HPR-PSA can demonstrate a D-shear strength of less than 2,000 Newton/inch, less than 1,000 Newton/inch, less than 900 Newton/inch, or less than 800 Newton/inch. In terms of lower limits, the HPR-PSA can demonstrate a D-shear strength of greater than 100 Newton/inch after curing, e.g., greater than 300 Newton/inch, or greater than 400 Newton/inch, or greater than 500 Newton/inch.

Methods for measuring storage modulus, the lap shear, steel peel strength, shear strength, Dynamic shear (“D-shear”) are also well known, for example, D-shear can be measured according to FINAT FTM-18 method (2016); the 180° C. peel strength can be measured according to the FINAT FTM-1 (2016) method, shear strength can be measured according to on the FINAT FTM-8(2016) method; and lap shear can be measured according to the ASTM D1002 (2016) method. Storage modulus can be measured using rheology analysis of TA Rheometer using the temperature ramp mode. In general, storage modulus measurements negatively correlate with the temperature under which the test is performed; for the PSAs having identical compositions, the higher the temperature the lower value of the storage modulus measurement. In some instances, storage modulus of the HPR-PSA is tested at 25° C. In some embodiments, storage modulus is tested at 170° C.

### EMBODIMENTS

Exemplary embodiments provided herein are flame retardant labels as follows:

Embodiment 1: An adhesive comprising: a first rubber comprising a styrene-isoprene-styrene (“SIS”) copolymer, a second rubber comprising a styrene-butadiene (“SB”) copolymer, a tackifier comprising a compound that is selected from the group consisting of hydrocarbon resin and rosin resin, and combinations thereof, and a curing agent comprising a phenolic resin.

Embodiment 2: an embodiment of embodiment 1, wherein the weight ratio of SIS to SB copolymers ranges from 4:1 to 0.25:1.

Embodiment 3: an embodiment of embodiment 1 or 2, wherein the curing agent comprises a phenolic derivative and is essentially free of sulfur.

Embodiment 4: an embodiment of any of the preceding embodiments, wherein the phenolic derivative comprises bromized phenol formaldehyde.

Embodiment 5: an embodiment of any of the preceding embodiments, wherein the bromized phenol formaldehyde is bromized alkyl phenol formaldehyde.

Embodiment 6: an embodiment of any of the preceding embodiments, wherein the adhesive comprises from 10 to 50 wt % SIS, based on the total weight of the adhesive.

Embodiment 7: an embodiment of any of the preceding embodiments, wherein the adhesive comprises from 10 to 50 wt % SB copolymer, based on the total weight of the adhesive.

Embodiment 8: an embodiment of any of the preceding embodiments, wherein the weight ratio of the tackifier to the combined SIS and SB copolymers ranges from 0.11:1 to 4:1.

Embodiment 9: an embodiment of any of the preceding embodiments, wherein the amount of rosin resin in the adhesive ranges from 0 to 50 wt % based on the total weight of the adhesive.

Embodiment 10: an embodiment of any of the preceding embodiments, wherein the amount of hydrocarbon resin in the adhesive ranges from 0 to 50 wt % based on the total weight of the adhesive.

Embodiment 11: an embodiment of any of the preceding embodiments, wherein the weight ratio of hydrocarbon resin to rosin resin ranges from 5:1 to 1:5.

Embodiment 12: an embodiment of any of the preceding embodiments, wherein the total amount of tackifier ranges from 10 to 75 wt % based on the total weight of the adhesive.

Embodiment 13: an embodiment of any of the preceding embodiments, wherein the hydrocarbon resin is selected from the group consisting of aliphatic hydrocarbon having 5 carbon atoms, aromatic hydrocarbon having 9 carbon atoms, dicyclopentadiene, and mixtures thereof.

Embodiment 14: an embodiment of any of the preceding embodiments, wherein the rosin resin is selected from the group consisting of glycerol ester, pentaerythritol ester, and mixtures thereof.

Embodiment 15: an embodiment of any of the preceding embodiments, wherein the curing agent is a mixture of alkyl phenol formaldehyde and bromized alkyl phenol formaldehyde.

Embodiment 16: an embodiment of any of the preceding embodiments, wherein the amount of curing agent ranges from 1 to 15 wt % based on the total weight of the adhesive.

Embodiment 17: an embodiment of any of the preceding embodiments, wherein the curing agent has a methylol content that ranges from 5 wt % to 18 wt % based on the weight of the curing agent.

Embodiment 18: an embodiment of any of the preceding embodiments, wherein the adhesive demonstrates a storage modulus of at least 300 Pa at 170° C. before being cured.

Embodiment 19: an embodiment of any of the preceding embodiments, wherein the adhesive demonstrates a storage modulus of at least 1800 Pa at 170° C. after being cured at 170° C. for 10 minutes, or the adhesive demonstrates at least a 5-fold increase as compared to the storage modulus before curing.

Embodiment 20: an embodiment of any of the preceding embodiments, wherein the adhesive demonstrates a peel strength of at least 8 Newton/inch on stainless steel according to the FINAT-1 (2016) method before curing.

Embodiment 21: an embodiment of any of the preceding embodiments, wherein the adhesive demonstrates a shear strength of at least 10,000 minutes on stainless steel according to the FINAT-8 (2016) method before curing.

Embodiment 22: an embodiment of any of the preceding embodiments, wherein the adhesive demonstrates a lap shear ranging from 0.05 MPa to 2 MPa on stainless steel before curing.

Embodiment 23: an embodiment of any of the preceding embodiments, wherein the adhesive demonstrates a lap shear of at least 1 Mpa on stainless steel after curing.

Embodiment 24: an embodiment of any of the preceding embodiments, wherein the adhesive demonstrates a D-shear ranging from 5 to 300 Newton/inch before curing.

Embodiment 25: an embodiment of any of the preceding embodiments, wherein the adhesive demonstrates a D-shear ranging from 100-2,000 Newton/inch after curing.

Embodiment 26: an adhesive solution for coating a facestock comprising: a first rubber comprising a styrene-isoprene-styrene (“SIS”) copolymer, a second rubber comprising a styrene-butadiene (“SB”) copolymer, a tackifier comprising a compound that is selected from the group consisting of hydrocarbon resin and rosin resin, and combinations thereof, a solvent, and a curing agent, wherein the curing agent is phenolic resin, wherein the weight ratio of SIS to SB copolymers ranges from 4:1 and 1:4.

Embodiment 27: A method of producing an adhesive solution comprising dissolving in a solvent at a temperature of less than 50° C. i) a first rubber comprising SIS copolymer, a second rubber comprising a SB copolymer, ii) a tackifier comprising a compound that is selected from the group consisting of hydrocarbon resin and rosin resin, and combinations thereof, iii) a curing agent, wherein the curing agent is phenolic resin to form an adhesive solution, wherein the weight ratio of SIS to SB copolymers ranges from 4:1 and 0.25:1.

Embodiment 28: an embodiment of embodiment 27, wherein the adhesive solution comprises between 25 wt % and 75 wt % solvent based on the total weight of the adhesive solution.

Embodiment 29: an embodiment of embodiments 27 or 28, wherein the adhesive solution demonstrates a viscosity of 100-5000 cps.

Embodiment 30: an embodiment of any of embodiments 27-29, wherein the adhesive solution has a solid content ranging from 30 wt % to 75 wt %.

Embodiment 31: an embodiment of any of embodiments 27-30, wherein the solvent is an aromatic solvent.

Embodiment 32: an embodiment of any of embodiments 27-31, further comprising coating a facestock with the adhesive solution and drying the adhesive solution at a temperature of less than 110° C. to produce an adhesive layer on the facestock.

Embodiment 33: A method for producing an adhesive, wherein the method comprises a) dissolving in a solvent at ambient temperature i) a first rubber comprising SIS copolymer, a second rubber comprising a SB copolymer, ii)a tackifier comprising a compound that is selected from the group consisting of hydrocarbon resin and rosin resin, and combinations thereof, iii) a curing agent, wherein the curing agent is phenolic resin to form an adhesive solution, wherein the weight ratio of SIS to SB ranges from 4:1 and 0.25:1, b) coating a facestock with the adhesive solution, and c) drying the adhesive solution at a temperature of less than 110° C., wherein the SIS and SB copolymers are substantially uncrosslinked.

Embodiment 34: A label comprising a facestock and an adhesive, wherein the adhesive is coated on the facestock and the adhesive comprises: a) a first rubber comprising a styrene-isoprene-styrene (“SIS”) copolymer, b) a second rubber comprising a styrene-butadiene (“SB”) copolymer, c) a tackifier comprising a compound that is selected from the group consisting of hydrocarbon resin and rosin resin, and combinations thereof, and d) a curing agent comprising a phenolic resin, wherein the weight ratio of SIS to SB copolymers ranges from 4:1 to 0.25:1, and wherein the SIS and the SB copolymers are substantially uncrosslinked.

Embodiment 35: an embodiment of any of embodiments 1-26, and 34, wherein the SIS and the SB copolymers are crosslinked to a degree of between 10% to 45% after being cured at 170° C. for 10 min.

Embodiment 36: an embodiment of any of embodiments 1-26, 34, and 35 wherein the label is attached to a tire.

Embodiment 37: A labeled tire comprising a tire and a label comprising the adhesive as described in any of the preceding embodiments.

### EXAMPLES

### Example 1

An HPR-PSA solution was prepared by dissolving in solution the component listed below:

TABLE 1
HPR-PSA solution components

| Component | Weight | Weight |
|---|---|---|
| (Manufacturer) | amount | percentage |
| QUINTAC 3270 SIS | 9.6 | 22.6% |
| (ZEON Chemical) | | |
| KIBIPOL PR-1205 | 6.4 | 15.2% |
| SB (CHIMEI) | | |
| Wingtack 10 | 7.6 | 18.1% |
| (hydrocarbon resin) | | |
| (Cray Valley) | | |
| Toluene (solvent) | 58 | — |
| Regalite C6100 | 8.8 | 21.0% |
| (hydrocarbon resin) | | |
| (Eastman) | | |
| GAl00F (rosin resin) | 7.2 | 17.1% |
| (ARAKAWA) | | |
| Phenolic resin SP1056 | 2.4 | 5.7% |
| (SI Group) | | |

The curing agent used in the HPR-PSA, SP1056, is bromized alkyl phenol formaldehyde and has a methylol group content of 9-11%. The HPR-PSA solution prepared above had a viscosity of 500 cps at 25° C. and had solid content of 42 wt %. The HPR-PSA was coated on 120 um PET film and dried at a temperature of lower than 110° C. to produce HPR-PSA labels.

The labels were tested for 180° C. peel strength on stainless steel at 23° C., 50% humidity according to FINAT FTM-1, with a balance time being 20 min and the width of the label being 1 inch and the peel rate being 300 mm/min. The balance time refers to the time of the label adhering on the substrate during the testing.

The shear strength on stainless steel was measured at 23° C., 50% humidity according to on the FINAT FTM-8 (2016) method with a balance time being 15 minutes and the width of the label being 0.5 inch.

D-shear was measured at 23° C., 50% humidity according to FINAT FTM-18 (2016) with a balance time being 20 minutes, the width of label being 0.5 inch, and the peel rate being 5mm/min.

Lap shear was measured at 23° C., 50% humidity according to the ASTM D1002 (2016) method. Two metal plates, with a thickness of 1.62 mm and an overlap of 12.7 mm (0.5″), were bonded with adhesive at testing. The adhesive specimen was 25.4 mm (1″) wide.

Storage modulus was measured using rheology analysis of TA Rheometer using the temperature ramp mode. The temperature ramped from -50° C. to 120° C. with 3° C./min heating rate and the angular frequency was 10 rad/s.

The label demonstrated a 180° C. peel strength of 16.5 Newton/inch on stainless steel, and a shear strength above 10000 min, and a D-shear strength of 89 Newton/inch on stainless steel.

The HPR-PSA label was then cured at 160□ for 10 min and tested for D-shear strength. The cured HPR-PSA demonstrated a D-shear strength of 1200 Newton/inch, significantly higher than those of the PSA before the curing. Likewise, the measurement of lap shear was increased to 1.12 Mpa and storage modulus were also significantly increased to 239,000 Pa when measured at 25° C. The comparison of the HPR-PSA before and after curing is shown in Table 2. The results indicate curing the HPR-PSA having the disclosed composition resulted in significant improvement in mechanical performance.

TABLE 2
Performance characteristics of the HPR-PSA before and after curing

| | | After curing |
|---|---|---|
| | | at 160° C. |
| | Before curing | for 10 min |
| Lap shear strength (Mpa) | 0.12 | 1.12 |
| D-shear (Newton/inch) | 89 | 1200 |
| Storage modulus (Pa) | 10500 (25° C.) | 239000 (2° C.) |
| 180° C. peel strength (Newton/inch) | 16.5 | — |
| Shear strength (min) | above 10,000 | — |

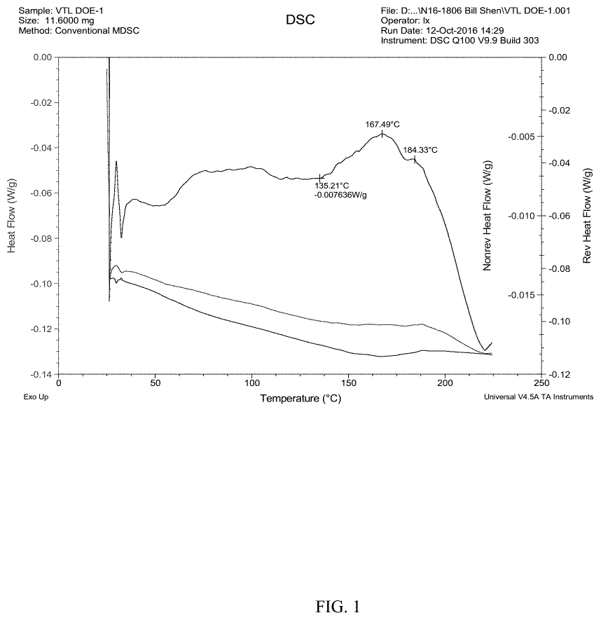

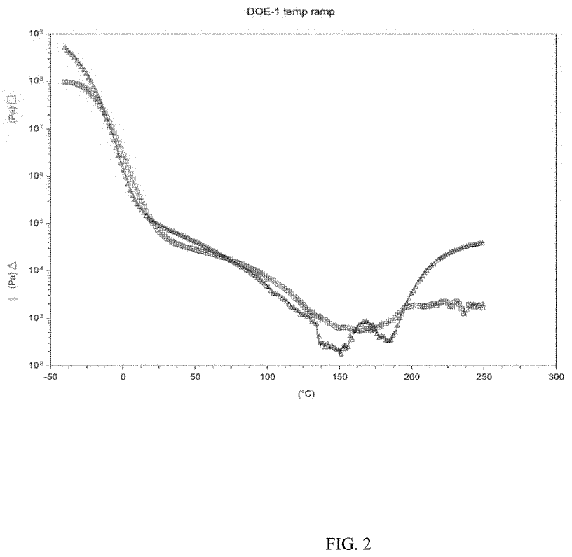

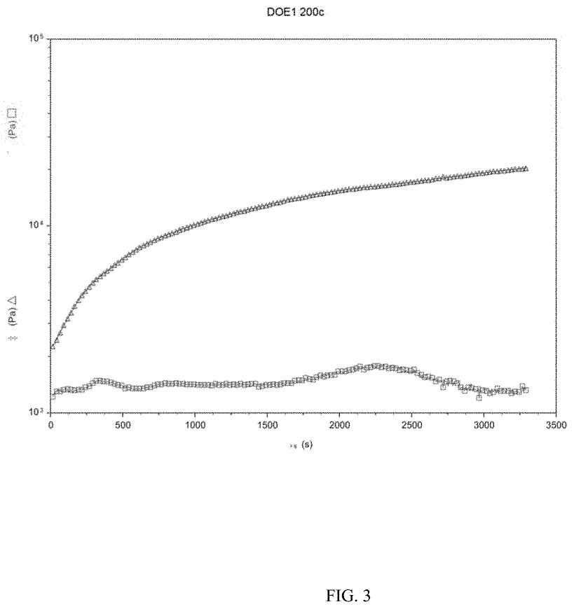

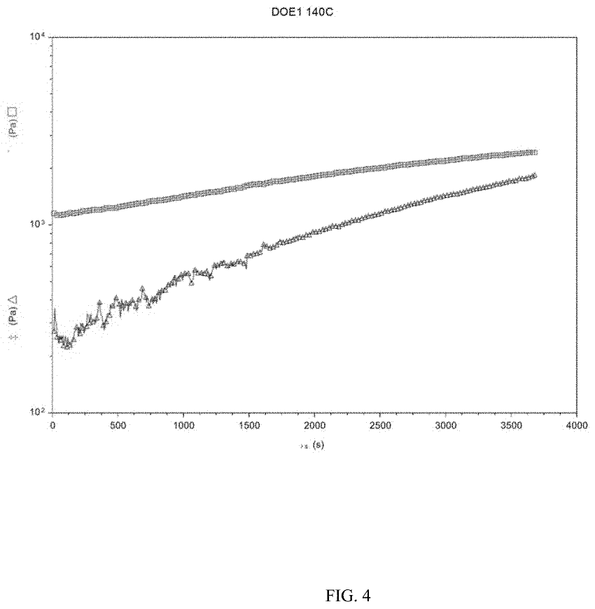

FIG. 1 shows results of the DSC analysis which indicates that the trigger temperature for curing was around 135 , where an exothermic peak started to form as the temperature increases. FIG. 2 shows results from rheology analysis by temperature ramp, which shows that the storage modulus (indicated by the blue line) continued to decrease as the temperature gradually increased to about 140° C., and when temperature continued to rise to 140° C. and higher the storage modulus increased dramatically. Time scanning experiments of curing at 200° C. (FIG. 3) and at 140° C. (FIG. 4) indicate that the storage modulus (also indicated by the blue lines) of the HPR-PSA steadily increased with time at both temperatures, reflecting that curing conferred increased mechanical performance. The steady increases of storage modulus also indicate no degradation or excessive crosslinking occurred while the HPR-PSA was being cured under either condition.

### Example 2

HPR-PSAs were manufactured as described above. These HPR-PSAs contained the identical compositions as disclosed in Example 1 except for the different amount of curing agent, the weight percentages of which are shown in Table 3, below. The HPR-PSAs were cured under the same condition as disclosed in Example 1 and the lap shear strength of each HPR-PSA was measured.

TABLE 3
Lap shear strength of HPR-PSAs
comprising curing agent of different levels

| | 1 | 2 | 3 | 4 | 5 | 6 | 7 | 8 | 9 |
|---|---|---|---|---|---|---|---|---|---|
| Cure agent | 0 | 0.50 | 1 | 2 | 4 | 6 | 10 | 15 | 30 |
| amount | | | | | | | | | |
| (wt %) | | | | | | | | | |
| Lap shear | 0.12 | 0.12 | 1.3 | 2.73 | 1.95 | 1.41 | 1.05 | 1.35 | 0.81 |
| strength | | | | | | | | | |
| (MPa) | | | | | | | | | |

As shown in Table 3, most examples (except for example 1, which did not utilize a curing agent) demonstrated high lap shear results. In particular, examples 3-8 showed particularly high lap shear values. However, the lap shear decreased significantly when the curing agent amount increased to 30 wt % (example 9). This indicates HPR-PSAs having the curing agent in an amount ranging from 1 wt % to 15 wt % had optimal mechanical properties after being cured.

### Example 3

In this example, a HPR-PSA was manufactured as described in Example 1. The HPR-PSA was cured at 170° C. for 10 min. The storage modulus before and after curing were measured and the HPR-PSA demonstrated a storage modulus at 170° C. of 490 Pa before curing and a storage modulus at 170° C. of 2490 Pa after curing.

### Example 4

HPR-PSAs were manufactured as described above. These HPR-PSAs contained the identical compositions as disclosed in Example 1 except for the different amount of curing agent, the weight percentages of which are shown in Table 4, below. Three HPR-PSAs for each curing agent amount group were manufactured. The HPR-PSAs were cured under the same condition as disclosed in Example 1 and the wt % of gel content, which represents the degree of crosslinking, were measured.

TABLE 4
Degrees of crosslinking in HPR-PSA
having various amounts of the curing agent

| Curing agent | | | | Average |
|---|---|---|---|---|
| amount (wt %) | wt % Gel Content | | | (wt %) |
| 0 | 1.9 | 1.9 | 2.1 | 2.0 |
| 0.50 | 1.7 | 0.4 | 2.5 | 1.5 |
| 6 | 23.0 | 24.0 | 26.2 | 24.4 |
| 15 | 41.7 | 41.0 | 41.1 | 41.3 |

As shown in Table 4, the degrees of crosslinking of the PSA having no curing agent were small, 2.1 wt % or less, or about 2.0 wt %. HPR-PSAs demonstrated desired mechanical performance in Example 2, i.e., HPR-PSAs having 6 wt % and 15 wt % of curing agent, showed degrees of crosslinking of 24.4% and 41.3%, respectively.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the invention.

1. An adhesive comprising:
a first rubber comprising a styrene-isoprene-styrene (“SIS”) copolymer,
a second rubber comprising a styrene-butadiene (“SB”) copolymer,
a tackifier comprising a compound selected from the group consisting of a hydrocarbon resin, a rosin resin, and mixtures thereof; and
a curing agent comprising a phenolic resin.

2. The adhesive of claim 1, wherein the weight ratio of SIS to SB ranges from 4:1 to 0.25:1.

3. The adhesive of claim 1, wherein the curing agent comprises a phenolic derivative and is essentially free of sulfur.

4. The adhesive of claim 2, wherein the phenolic derivative comprises bromized phenol formaldehyde.

5. The adhesive of claim 4, wherein the bromized phenol formaldehyde is bromized alkyl phenol formaldehyde.

6. The adhesive of claim 1, wherein the adhesive comprises from 10 to 50 wt % SIS, based on the total weight of the adhesive.

7. The adhesive of claim 1, wherein the adhesive comprises from 10 to 50 wt % SB, based on the total weight of the adhesive.

8. The adhesive of claim 1, wherein the weight ratio of the tackifier to the combined SIS and SB copolymers ranges from 0.11:1 to 4:1.

9. The adhesive of claim 1, wherein the amount of rosin resin in the adhesive ranges from 0 to 50 wt % based on the total weight of the adhesive.

10. The adhesive of claim 1, wherein the amount of hydrocarbon resin in the adhesive ranges from 0 to 50 wt % based on the total weight of the adhesive.

11. The adhesive of claim 1, wherein the weight ratio of hydrocarbon resin to rosin resin ranges from 1:0 to 0:1.

12. The adhesive of claim 1, wherein the total amount of tackifier ranges from 10 to 75 wt % based on the total weight of the adhesive.

13. The adhesive of claim 1, wherein the hydrocarbon resin is selected from the group consisting of aliphatic hydrocarbon having 5 carbon atoms, aromatic hydrocarbon having 9 carbon atoms, dicyclopentadiene, and mixtures thereof.

14. The adhesive of claim 1, wherein the rosin resin is selected from the group consisting of glycerol ester, pentaerythritol ester, and mixtures thereof.

15. The adhesive of claim 1, wherein the curing agent is a mixture of alkyl phenol formaldehyde and bromized alkyl phenol formaldehyde.

16. The adhesive of claim 1, any wherein the amount of curing agent ranges from 1 to 15 wt % based on the total weight of the adhesive.

17. The adhesive of claim 1, wherein the curing agent has a methylol content that ranges from 5 wt % to 18 wt % based on the weight of the curing agent.

18. The adhesive of claim 1, wherein the adhesive demonstrates a storage modulus of at least 300 Pa at 170° C. before being cured.

19. The adhesive of claim 1, wherein the adhesive demonstrates a storage modulus of at least 1800 Pa at 170° C. after being cured at 170° C. for 10 minutes, or the adhesive demonstrates at least a 5-fold increase as compared to the storage modulus before curing.

20. The adhesive of claim 1, wherein the adhesive demonstrates a peel strength of at least 8 Newton/inch on stainless steel according to the FINAT-1 (2016) method before curing.

21. The adhesive of claim 1, wherein the adhesive demonstrates a shear strength of at least 10,000 minutes on stainless steel according to the FINAT-8 (2016) method before curing.

22. The adhesive of claim 1, wherein the adhesive demonstrates a lap shear ranging from 0.05 MPa to 2 MPa on stainless steel before curing.

23. The adhesive of claim 1, wherein the adhesive demonstrates a lap shear of at least 1 Mpa on stainless steel after curing.

24. The adhesive of claim 1, wherein the adhesive demonstrates a D-shear ranging from 5 to 300 Newton/inch before curing.

25. The adhesive of claim 1, wherein the adhesive demonstrates a D-shear ranging from 100-2,000 Newton/inch after curing.

26. An adhesive solution for coating a facestock comprising:
a first rubber comprising a styrene-isoprene-styrene (“SIS”) copolymer,
a second rubber comprising a styrene-butadiene (“SB”) copolymer,
a tackifier comprising a compound selected from the group consisting of a hydrocarbon resin, a rosin resin, and combinations thereof,
a solvent, and
a curing agent, wherein the curing agent is phenolic resin.

27. A method of producing an adhesive solution comprising
dissolving in a solvent at a temperature of less than 50° C.
i) a first rubber comprising SIS copolymer, a second rubber comprising a SB copolymer,
ii) a tackifier comprising a compound selected from the group consisting of a hydrocarbon resin, a rosin resin, and combinations thereof,
iii) a curing agent, wherein the curing agent is phenolic resin.
to form an adhesive solution.

28. The adhesive solution of claim 26, wherein the adhesive solution comprises between 25 wt % and 75 wt % solvent based on the total weight of the adhesive solution.

29. The adhesive solution of claim 26, wherein the adhesive solution demonstrates a viscosity of 100-5000 cps.

30. The method of claim 27, further comprising coating a facestock with the adhesive solution and drying the adhesive solution at a temperature of less than 110° C. to produce an adhesive layer on the facestock.

31. The adhesive solution of claim 26, wherein the adhesive solution has a solid content ranging from 30 wt % to 75 wt %.

32. The adhesive solution of claim 26, wherein the solvent is an aromatic solvent.

33. A method for producing an adhesive, wherein the method comprises
a) dissolving in a solvent at ambient temperature
i) a first rubber comprising SIS copolymer, a second rubber comprising a SB copolymer,
ii) a tackifier comprising a compound selected from the group consisting of a hydrocarbon resin, a rosin resin, and combinations thereof,
iii) a curing agent, wherein the curing agent is phenolic resin.
to form an adhesive solution,
b) coating a facestock with the adhesive solution, and
c) drying the adhesive solution at a temperature of less than 110° C.,
wherein the SIS and SB copolymers are substantially uncrosslinked.

34. A label comprising a facestock and an adhesive, wherein the adhesive is coated on the facestock and the adhesive comprises:
a) a first rubber comprising a styrene-isoprene-styrene (“SIS”) copolymer,
b) a second rubber comprising a styrene-butadiene (“SB”) copolymer,
c) a tackifier comprising a compound selected from the group consisting of a hydrocarbon resin, a rosin resin, and combinations thereof, and
d) a curing agent comprising a phenolic resin, and
wherein the SIS and the SB copolymers are substantially uncrosslinked.

35. The label of claim 33, wherein the SIS and the SB copolymers are crosslinked to a degree of between 10% to 45% after being cured at 170° C. for 10 min.

36. A tire label comprising the adhesive of claim 1, wherein the label is attached to a tire.

37. A labeled tire comprising a tire and a label comprising the adhesive of claim 1.
